(19) United States
(12) Patent Application Publication
(10) Pub. No.: US 2021/0150624 A1
(43) Pub. Date: May 20, 2021

(54) INTELLIGENT POPULATION OF INTERFACE ELEMENTS FOR CONVERTING TRANSACTIONS

(71) Applicant: PAYPAL, INC., San Jose, CA (US)

(72) Inventors: Faith A. Tucker, Overland Park, CA (US); Megan Carmellini, Augusta, MD (US)

(21) Appl. No.: 16/687,554

(22) Filed: Nov. 18, 2019

(51) Int. Cl. G06Q 40/02; G06Q 20/36; G06Q 20/10; H04L 29/06; G06N 20/00

(52) U.S. Cl. CPC G06Q 40/025; G06Q 20/3678; G06N 20/00; H04L 63/08; G06Q 20/102

(57) ABSTRACT

There are provided systems and methods for intelligent population of interface elements for converting transactions. A service provider, such as an online digital wallet provider and/or transaction processor, may provide analysis of a transaction history output through a data display in an application or a website. The service provider may determine whether any past transactions may be converted or flipped from a past outgoing payment to one or more installment loans for all or a portion of the payment. This may be determined using a recommendation engine trained using one or more factors and past data. If a transaction qualifies for an offer to flip the past payment to an installment loan, the service provider may populate one or more interface elements and/or data that allows the user to accept or decline the offer.

### TECHNICAL FIELD

The present application generally relates to intelligently displaying interface data and elements within a data feed and more particularly to dynamically displaying interface elements that allow a user to convert previously completed transactions to a different type of transaction.

### BACKGROUND

Users may utilize computing devices to perform electronic transaction processing with other devices. Online entities may provide digital wallets to users, which include funds and/or payment instruments that allow a user to process transactions with other users, merchants, and the like. The digital wallet may be accessible through a dedicated application and/or one or more online web portals that output interfaces that users may utilize to process data with the entities, such as transactions and/or voluntary payments. For example, provided content may include past processed transactions, including transaction data of an amount, receiving entity, items purchased, or other information. Because such content is for transactions already completed, use of such content is typically limited to budgeting, tracking, and the like. Therefore, expanding uses of content provided with processed transactions would be desirable to both users and service providers.

### BRIEF DESCRIPTION OF THE DRAWINGS

FIG. 1 is a block diagram of a networked system suitable for implementing the processes described herein, according to an embodiment;

FIG. 2 is a first exemplary interface for dynamically displaying interface elements and options to convert a past processed transaction to an installment loan or other revolving account transaction, according to an embodiment;

FIG. 3 is an exemplary system environment where a user device and a transaction processor may interact to intelligently determine and display interface options to convert a past processed transaction to an installment loan, according to an embodiment;

FIG. 4A is a flowchart of an exemplary process for intelligent population of interface elements for converting transactions, according to an embodiment;

FIG. 4B is a flowchart of an exemplary process for intelligent population of interface elements for converting transactions based on a budget of a user, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for intelligent population of interface elements for converting processed or completed transactions. Systems suitable for practicing methods of the present disclosure are also provided.

A user may pay for one or more transactions using a digital wallet or other account with an online service provider or other transaction processor (e.g., PayPal®). An account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments, which may be used to process transactions after identity confirmation. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services. These accounts may be accessed to determine the user and/or entity data and may also be used by the users to process transactions based on the dynamically presented data within the payment interface.

Thus, the online service provider may provide account services to users of the online service provider, which may be used to process electronic transactions. A user wishing to establish the account may first access the online service provider and request establishment of an account. In order to pay for the transaction (e.g., a transfer or payment to another user, merchant, or other entity), the user may provide user financial or funding source information or may login to an account with the service provider through authentication information and process the transaction using the account. A payment may then be issued to the other party to the transaction and transaction information may be stored with the digital wallet or account. Thereafter, the user may utilize one or more interfaces, data feeds, and/or content platforms to review transaction information, such as a transaction history that may be viewable on a website or through a dedicated application. The transaction information may show an amount, time, the receiving party, the used funds or payment instrument, a message or transaction details, or other information. The service provider may also store other transaction information, which may be accessible by the user or only accessible to the service provider, including merchant identifiers, item identifiers or SKUs, transaction metadata, user spending habits or preferences, and other types of data associated with the transaction.

After processing a transaction, a user may view data having some or all of the transaction information through a display. The display may be accessible through the account and associated with the account/digital wallet of the user. When viewing the display, the user may interact with particular transactions and transactional data. Moreover, the user may view spending information, such as a monthly spending amount, budget, spending statistics or graphs, and other information associated with the user's payment instruments and/or digital wallet. The user may also interact with the service provider to set preferences and other information for the user, such as budgetary goals, required balances, upcoming or recurring bills, expected assets (e.g., tax returns, expected incoming including salary payments or hourly wages, etc.), and other types of information that may be relevant to the user's funds and required payments.

Using the information in the digital wallet, the service provider may automatically and dynamically determine previously paid-for transactions (e.g., past payments of the user) to offer the user to flip or convert the transaction into an installment loan. In other embodiments, other types of revolving account transaction, credit, or loan may also be used to convert the previous transaction, such as a credit offer (e.g., PayPal Credit® transaction where credit is extended for the transaction). Thus, although the “flip offer” is discussed in reference to an installment loan herein, other types of extended loans or credit may also be provided for conversion of a past paid-for transaction into the particular loan or credit. A “flip offer” may constitute an extended offer to the user to convert the past completed transaction into a loan that deposits some or all of the previously-used funds into the user's account, which may correspond to the installment loan, a revolving account transaction, or other type of extended credit or loan that allows for the user to receive some amount of immediate funds and repay those funds over a period of time (which may or may not have an applicable interest rate). This completed transaction may correspond a processed transaction by a transaction processor using a payment instrument that includes an amount or payment transferred or paid to another party. In order to repay the loan amount, the user may be responsible for a monthly (or other time frame) payment for a portion of the loan's principle and/or interest. In some embodiments, the loan may have a flat fee or percentage fee amount for the principle loan that may be due to the loaner (e.g., the service provider or a loaning entity, such as a bank, associated with the service provider) by the loanee (e.g., the user). Thus, the user may be responsible for a periodic payment amount, which may be automatically deducted from or charged to the user's account or digital wallet. The installment loan may be for all of or a portion of the transaction cost or amount.

In order to determine which transactions to offer the user to flip or convert into an installment loan, the service provider may utilize the transaction information in the transaction history for the user. For example, the amount, date, and/or items purchased may be used to determine whether the transaction is eligible or selected to be flipped. The transaction amount may be used to determine whether the flip loan would exceed a maximum cap on one or more installment loans offered to the user by the service provider or other loaner. Moreover, the loaner may also limit a maximum number of loans extended to the user. The maximum cap may be set by the system for all users or may be specific to certain users. For example, the service provider or other transaction processor may limit all users to three total installment loans that may be offered and/or accepted, and/or may limit the total amount to $5,000. In other embodiments, the maximum cap may be user specific, for example, based on past repayment factors, credit worthiness, available funds and/or other debts, credit extensions and amount of credit used, and other factors that may be used to determine a trustworthiness or loan availability to a specific user. Additionally, the service provider may filter the transactions within the user's transaction history on additional factors, such as transaction types. For example, credit purchases by the user may be ineligible to be flipped to an installment loan or other credit to prevent payment of past credit transactions with additional credit. The transaction type may include a partner service provider of the service provider that is used to filter transactions, such as a particular partner or a card type used for the past transaction. The transaction type may be filtered by additional factors, such as cross board trade, item types (e.g., firearms or gambling type purchases), and the like. Thus, the transaction type of transactions in the transaction history may be filtered for eligibility concerns established by the service provider, which may be universal or for a particular loan or credit extension type

In this regard, the items, merchant, or time/date may affect whether a transaction is offered to be flipped. Such information may indicate whether an installment loan is subject to potential fraud. For example, quasi-cash (e.g., gift cards or easily returnable items for cash, including casino gambling chips and the like), may be easily converted to cash, which may cause potential fraud with malicious users that accept the installment loan and then not complete payments after converting the items to cash. Return policies may dictate whether a purchased item may be easily returned for cash, and thus open an installment loan offered on those items to potential fraud. Thus, such transactions may not be offered to be flipped. Additionally, a payment instrument used for the transaction may be used to determine whether to offer a flip or conversion of a transaction into an installment loan. In such embodiments, predefined rules may be referenced, which \ dictate whether the service provider or other loaner offers an installment loan. Such predefined rules may be generated and implemented with the system based on application rules, which may correspond partner platforms and entities of the service provider that engage in similar services to users. Additionally, user information, such as a past history of the user in loan repayments, other assets or debts of the user, and the like may be used to determine which transactions qualify to be offered to be flipped, if any.

Additionally, the service provider may utilize the user's set budgetary information to determine which transactions to offer to flip into an installment loan. The budget may be used to determine if the user needs funds in their digital wallet for an upcoming payment. In this regard, the user may have monthly payments required by the user, such as bills. The user may also require a minimum balance or have set an upcoming expected purchase or desired item that the user requires funds to complete. In some embodiments, such information may be scraped from online data, such as social networking accounts, microblogging accounts, image posts or image feeds of the user, messages between users, and/or media sharing or viewing actions of the user. User permissions and/or opt-in acceptance may be required for obtaining and use of such information. For example, the user may indicate that they have to get their car fixed for $1,000 in a month but the service provider may determine the user either does not have the funds or the funds would adversely affect a balance or budgetary concern. In some embodiments, the purchase may be a group purchase indicated by the user with other users. For example, the user may set up a pool for a vacation purchase with three other users, where the first user is responsible for $500 of the vacation expense. Thus, the service provider may determine that the user requires a $500 loan and check for eligible past transactions to offer to be flipped into an installment loan.

The service provider may utilize the digital wallet of the user to determine account balances (including checking/savings, deposit, credit card, or other account type), credit limits, extended loans and loan balances, and the like. For example, the user may opt-in to the service provider controlling or managing the user's expenses, such as through budgetary information and/or preferences set by the user. If so, the service provide may have information on the user's desired account balances, monthly spending limits (which may be per item, item type, or account wide), required bills and outgoing payments, incoming assets and payments (e.g., a salary, hourly wages, work schedule, tips, and the like), spending patterns, and other information.

Using the aforementioned information, the service provider may determine whether a user requires or may desire an installment loan for an amount, and how much the amount may be. For example, the service provider may determine that the user will have a deficit in their budget based on purchases and/or incoming wages or payments. The deficit may be caused by a purchase of a larger or otherwise uncommon item or another completed transaction that may adversely affect the user's budget. In other embodiments, the user's incoming assets may be less than required by the user's budget and/or the user may be responsible for an upcoming bill or other required payment that will adversely affect the user's budget. Thereafter, the service provider may utilize the qualifying or eligible transactions to offer to flip for the user for that amount and when to offer the user the installment loan flip(s) to satisfy the required budgetary amount for the user. In such embodiments, the service provider may score each of the qualifying past transactions (and therefore qualifying potential installment loans) and may offer a subset from the group based on exceeding a threshold or being a highest one or highest subset of the scored qualifying past transactions. The number of transactions and/or total amount of funds offered from transactions that are selected based on their scores may be determined by the capped total amount and/or number of installment loan offers. In some embodiments, a scored transaction may be required to meet at least a threshold prior to being offered to flip to an installment loan. The scoring may also be based on the deficit amount of the digital wallet with respect to the user's budget. Thus, some users and/or transaction data displays may include no offers for transaction flipping or converting into an installment loan or may include a plurality of transactions. The flip offer may be provided prior to the expected purchase or other budgetary constraint in the digital wallet to intelligently and predictively offer the user the funds prior to the user requiring the funds (thereby preserving their account balance and eliminating adverse consequences of overdrawn accounts).

The service provider may also identify large and/or uncommon past purchases and transactions of the user that may be used to determine if those transactions are eligible for a flip offer into an installment loan, or otherwise determine other transactions to offer to be flipped for the transaction amount. For example, the user may purchase a new television for $600 in one month, which is both uncommon and a large purchase that negatively affects the user's budget and/or account balance(s) (e.g., by not having enough for an upcoming bill or reducing the user's balance below a budgetary preference). Thus, the service provider may determine whether that purchase is eligible to be flipped into an installment loan to cover the purchase cost and spread the purchase cost out over a period of time to cover. If the specific past transaction is ineligible, the service provider may determine other transactions that may be eligible to offer to be flipped that may cover the purchase cost. In other embodiments, if a past transaction cannot be converted due to the amount, a determination may be made that two or more installment loans may be applied to the transaction to limit the exposure of the loan, such as when two or more different loaners are offering the installment loans. The determination of whether to attempt to flip the past transaction may be done in a similar manner to determining eligible or qualifying transactions to be offered to be flipped. In some embodiments, the logic of the service provider's engine to determine the flip offers may determine that a past transaction is ineligible or does not show up as eligible due to rules (e.g., over a certain transaction size or limit, due to past user information, etc.). However, within a details page or view of the transaction history and/or particular transaction, an interface option and/or element may allow the user to require a flip evaluation of the past transaction by the service provider, where the service provider may perform another or more detailed evaluation of the transaction for flipping.

In some embodiments, several or all transactions may qualify to be offered to be flipped into an installment loan by the service provider. However, this may cause the total amount or number of installment loans to exceed a maximum cap set by the service provider, which may be system-wide or user-specific. Thus, the service provider may only provide certain ones of the available flip offers of completed transactions to installment loans in order to preserve the limitations of installment loan caps. In some embodiments, the service provider may automatically score and/or select transactions offered to be flipped to installment loans without user input or a user request, for example, based on the user budget, data, or other information. However, in other embodiments, the user may either opt-in to receiving offers for flipping past transactions to installment loans or may request that the service provider score and/or identify offers to flip previous transaction payment amounts into an installment loan (e.g., when a user is shopping for a loan or may require loan funds).

If a transaction is determined to be valid to be flipped into an installment loan for all or a portion of the transaction's payment, then the service provider may extend the offer through one or more messages, digital wallet interface elements, and/or transaction data displays for the user. In this regard, a transaction history may be accessible and viewable through a display on an application or through a website. The display may include previous transaction information and interface elements, fields, or options that allow the user to interact with the previous transaction(s), such as to view additional information. Another interface element may be dynamically generated, populated, and/or displayed in response to the service provider determining that the particular transaction is eligible to be flipped to an installment loan. The interface element may correspond to an interface option, menu option, selection field, or the like that allows a user to accept the transaction to be flipped into an installment loan. Thus, selection of the interface element may initiate a process to obtain the installment loan on behalf of the user, such as a user agreement to the installment loan. The interface element may be displayed through an interactive interface and allow the user to accept terms of an installment loan, as well as view those terms or negotiate the terms as necessary. The data used to extend the offer may only constitute an offer to flip the transaction to an installment loan and may not automatically accept the offer or provide the amount for the installment loan to the user.

If the service provider receives an acceptance of the offer to flip all or a portion of a previous outgoing payment for a transaction to an installment loan, the service provider may further determine whether the user and/or transaction still qualifies to be flipped. For example, the service provider may receive user input associated with the interface element that indicates an acceptance of the offer for the installment loan, such as click a button or moving an interface option. Additionally, the service provider may present the interface element as other data through another interface, such as an audio interface through a speaker. Acceptance of the flip offer may be performed through mouse/keyboard, touch, voice, or other input, such as through a mobile phone, chat application, or microphone/speaker system. The service provider may utilize the user data, transaction data, and/or intelligent scoring system to determine whether the offer is still valid for the installment loan. This may include checking further information than what was initially used to offer the installment loan (e.g., a credit check with a credit scoring agency). If the offer is still valid, the service provider may initiate a process to extend the installment loan to the user, such as by requesting additional user information and/or connecting the user with a loan extension agent or process. However, if the offer is no longer valid, the service provider may revoke the option and notify user that the offer is no longer valid (e.g., due to a change in offer data for the installment loan, meeting a cap of installment loan amount or number, etc.). The service provider may further update all or a portion of the interface elements associated with the offers based on whether the offer was valid and may re-score other transaction flip offers. Additionally, the service provider may monitor the past transaction for the flip offer to determine whether the transaction is reversed (e.g., a return of items or other reversal of the transaction that returns funds for the transaction to the user). If the past transaction is reversed, the service provider may determine another past transaction that may be flipped into an installment loan or credit offer, as discussed herein. The installment loan for the past transaction that was reversed may be paid off using the returned funds, or the user may be presented with an option of maintaining the loan, paying off the loan, and/or determining another past transaction to flip.

Thus, a service provider may provide intelligent predictions on interface data for display to a user so that the interface may be customized to particular users and entities for flipping transactions into installment loans. This reduces required user navigations through an online service or resource (e.g., a website or other online platform accessible through an application) in order to locate, receive, and/or process relevant installment loan data. Thus, the user may view offers and interact with those offers in a more convenient and simplified interface. Additionally, the user does not need to provide input of data for installment loan acquisition and may view a streamlined version of interface data and processing with the service provider. Further, by suggesting one or more transactions to flip to an installment loan that is specific to a user, the user is more likely to proceed with the installment loan, resulting in benefits for both the loaner and the user, as well as reduced friction for both the service provider and the user in determining installment loan terms. An additional benefit is to future merchants or other entities that the user may need or want to make payments to, which without the ability to convert a previous transaction, would render the user unable to make such payments. The user may be provided with a location or website/application functionality that allows the user to view the eligible past transactions for a flip offer, which may be displayed together so that the user may view all related flip offers through a convenient interface. The user may be able to search within the interface to find particular flip offers and/or past transactions, as well as select the flip offers and/or past transactions for further viewing and interaction. The user may be able to enter their loan and/or credit application information once through the interface and/or feature so that individual transactions may be offered to be flipped to an installment loan (or other offer, such as credit extension, revolving credit transaction, and the like).

Additionally, the user may be allowed to aggregate multiple eligible transactions into a single installment loan or other offer to receive a particular amount that the user requires. The interface and corresponding feature may also allow the user to enter an amount required by the user, where the service provider may then determine eligible past transactions for flipping to reach that amount. Thus, the user may then select eligible transactions to flip so that the user may reach the required amount. For example, if the user requires $500, the user may view a transaction A for $300, a transaction B for $200, a transaction C for $150, and a transaction D for $50 that are eligible to be flipped. The user may then select some combination (e.g., transactions A and B or transactions A, C, and D) to flip into the required $500. If the combination of transactions exceeds the total required amount (e.g., $500), then the user may elect to only convert a portion of one or more of the transactions to flip to the installment loan. The transactions may be determined by the service provider for “clubbing” or clustering together for a single installment loan or may be designated by the user. In this regard, a functionality to identify the particular transactions for an installment loan may be identified by a name, description, photograph of an item or receipt, or other transaction data. The interface may also provide a summary of active flipped transactions (e.g., installment loans resulting from flipping a past transaction), such as information from the original transaction and information from the flip offer/installment loan (e.g., loan date, terms, interest rate, number of remaining payments, date of payoff, outstanding balance, as well as user naming, description, or photograph from the transaction or installment loan).

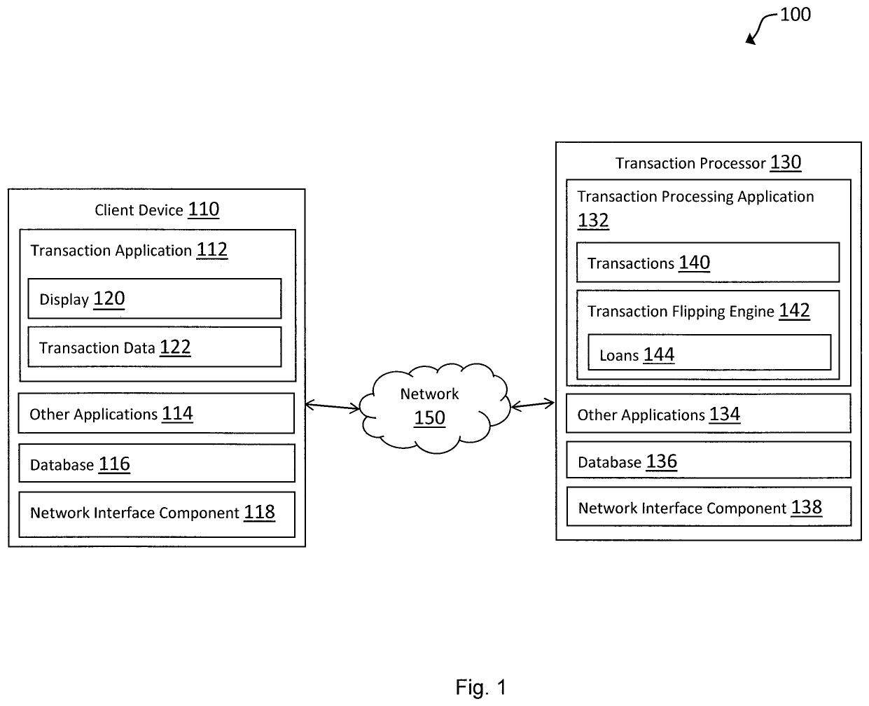

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity

System 100 includes a client device 110 and a transaction processor 130 in communication over a network 150. Client device 110 may be utilized by a user to access an interface that allows electronic transaction processing and/or view data of processed transactions through one or more interfaces. Transaction processor 130 may provide optimization of data output on this interface through analysis of data for the user and/or transaction, which may include extending offers to flip payment amounts for the previous transactions to installment loans for the amounts. Transaction processor 130 may implement an engine to determine the data and customize the interface display based on the data, such as by dynamically generating, populating, and/or displaying interface data and elements allowing for acceptance of an installment loan.

Client device 110 and transaction processor 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a communication device that may utilize appropriate hardware and software configured for wired and/or wireless communication with transaction processor 130. For example, in one embodiment, client device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one device is shown, a plurality of devices may function similarly and/or be connected to provide the functionalities described herein.

Client device 110 of FIG. 1 contains a transaction application 112, other applications 114, a database 116, and a network interface component 118. Transaction application 112 and other applications 114 may correspond to executable processes, procedures, and/or applications with associated hardware. In other embodiments, client device 110 may include additional or different modules having specialized hardware and/or software as required.

Transaction application 112 may correspond to one or more processes to execute software modules and associated components of client device 110 to process electronic transactions over a network with one or more other services and/or users, as well as view data of processed transactions and accept offers to flip or convert processed transaction payments into installment loans. In this regard, transaction application 112 may correspond to specialized hardware and/or software utilized by a user of client device 110 that may be used to access a website or an interface of transaction processor 130 that allows client device 110 to enter or receive transaction data for a transaction (e.g., a payment to another entity, such as a user, merchant, or other payee), provide an account, financial data, or a digital token used to pay for the transaction data, and instruct transaction processor 130 to perform transaction processing. Transaction application 112 may utilize one or more user interfaces, such as graphical user interfaces presented using an output display device of client device 110, to enable the user associated with client device 110 to enter and/or view interface data, where the interface data may be customized and dynamically output based on offers for flipping previous transactions to installment loans generated by transaction processor 130. In some embodiments, transaction application 112 may display this interface data through a display 120 that includes transaction data 122.

Transaction application 112 may be used to provide information for the user, which may include transaction histories for the user for an account of the user. During transaction processing, transaction application 112 may be utilized to select payment instrument(s) for use in providing payment for a purchase transaction, transfer, or other financial process. As discussed herein, transaction application 112 may utilize user financial information, such as credit card data, bank account data, or other funding source data, as a payment instrument when providing payment information. Additionally, transaction application 112 may utilize a digital wallet associated with an account with a payment provider, such as transaction processor 130, as the payment instrument, for example, through accessing a digital wallet or account of a user with transaction processor 130 through entry of authentication credentials and/or by providing a data token that allows for processing using the account. Transaction application 112 may also be used to receive a receipt or other information based on transaction processing, including transaction data 122 in display 120.

For example, display 120 may correspond to a data feed for a transaction history of an account and/or digital wallet that displays all or a subset of previously processed transactions with transaction data 122. In some embodiments, transaction data 122 may include interface data and interface elements that allow for interaction with the information for transaction data 122. Additionally, transaction data 122 may include interface elements, data, and information associated with offers to flip or convert one or more of the previous transactions into one or more installment loans of all or a part of the payment total of the previous transaction. Such data may be determined by transaction processor 130, as discussed herein. The flip option(s) may be displayed through display 120 into transaction application 112. In various embodiments, transaction application 112 may correspond to a general browser application configured to retrieve, present, and communicate information over the Internet (e.g., utilize resources on the World Wide Web) or a private network. For example, transaction application 112 may provide a web browser, which may send and receive information over network 150, including retrieving website information (e.g., a website for transaction processor 130), presenting the website information to the user, and/or communicating information to the website, including payment information for transaction processed through transaction processor 130. However, in other embodiments, transaction application 112 may include a dedicated application of transaction processor 130 or other entity (e.g., a merchant), which may be configured to assist in processing transactions electronically, including transactions processed using the digital token. The interface(s) providing by transaction application 112 may be utilized to engage in electronic transaction processing, as well as viewing and acceptance of flip offers to convert a transaction to one or more installment loans.

In various embodiments, client device 110 includes other applications 114 as may be desired in particular embodiments to provide features to client device 110. For example, other applications 114 may include security applications for implementing client-side security features, programmatic client applications for interfacing with appropriate application programming interfaces (APIs) over network 150, or other types of applications. Other applications 114 may include device interface applications and other display modules that may receive input from the user and/or output information to the user. For example, other applications 114 may contain software programs, executable by a processor, including a graphical user interface (GUI) configured to provide an interface to the user. Other applications 114 may therefore use components of client device 110, such as display components capable of displaying information to users and other output components, including speakers.

Client device 110 may further include database 116 stored on a transitory and/or non-transitory memory of client device 110, which may store various applications and data and be utilized during execution of various modules of client device 110. Database 116 may include, for example, identifiers such as operating system registry entries, cookies associated with transaction application 112 and/or other applications 114, identifiers associated with hardware of client device 110, or other appropriate identifiers, such as identifiers used for payment/user/device authentication or identification, which may be communicated as identifying the user/client device 110 to transaction processor 130. Moreover, database 116 may include user data necessary to determine an installment loan offer based on flipping an amount of a transaction to the loan, or other information used by transaction processor 130. Database 116 may store received transaction data and installment loan offer data for display 120, such as transaction data 122.

Client device 110 includes at least one network interface component 118 adapted to communicate with transaction processor 130. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Transaction processor 130 may be maintained, for example, by an online service provider, which may provide processing of transactions, as well as extensions of offers to flip previous transactions to installment loans. In this regard, transaction processor 130 includes one or more processing applications which may be configured to interact with client device 110 to access user and transaction data, determine flip offers for installment loans using a machine learning engine, and provide interface data and elements to view and accept the flip offers. In one example, transaction processor 130 may be provided by PAYPAL®, Inc. of San Jose, Calif., USA. However, in other embodiments, transaction processor 130 may be maintained by or include another type of service provider.

Transaction processor 130 of FIG. 1 includes a transaction processing application 132, other applications 134, a database 136, and a network interface component 138. Transaction processing application 132 and other applications 134 may correspond to executable processes, procedures, and/or applications with associated hardware. In other embodiments, transaction processor 130 may include additional or different modules having specialized hardware and/or software as required.

Transaction processing application 132 may correspond to one or more processes to execute modules and associated specialized hardware of transaction processor 130 to process a transaction, as well as intelligently determine offers to flip or convert previous transactions to installment loans. In this regard, transaction processing application 132 may correspond to specialized hardware and/or software used by a user associated with client device 110 to establish a payment account and/or digital wallet, which may be used to generate and provide user data for the user, as well as process transactions and accept installment loan offers. In various embodiments, financial information may be stored to the account, such as account/card numbers and information. A digital token for the account/wallet may be used to send and process payments, for example, through an interface provided by transaction processor 130. In some embodiments, the financial information may also be used to establish a payment account. The payment account may be accessed and/or used through a browser application and/or dedicated payment application executed by client device 110 and engage in transaction processing through transaction processing application 132. Transaction processing application 132 may process the payment and may provide a transaction history to client device 110 for transaction authorization, approval, or denial.

Additionally, after processing one or more of transactions 140, transaction processing application 132 may be used to determine whether any of transactions 140 for a user qualify to be flipped to one or more installment loans for all or part of the purchase cost of the transaction. For example, a recommendation machine learning engine, such as transaction flipping engine 142, may be used to process transaction 140 with additional data to determine loans 144. Loans 144 may correspond to completed transactions that are offered to be flipped to installment loans by transaction processor 130. Thus, loans 144 may include data for the previously completed transactions, including scoring data of the transactions, with additional data that causes generation of a flip offer of the completed transactions to installment loans. In this regard, loans 144 may also include data associated with the flip offer of the completed transaction to the installment loan, such as budgetary information indicating a deficit in a user's budget that causes transaction processor 130 to determine flip offers for the user.

In this regard, transaction flipping engine 142 may access data for transactions 140 to determine whether any of transactions 140 are eligible to be flipped into installment loans, such as based on the transaction details (e.g., items, merchant, amount, time, etc.). Additionally, transaction flipping engine 142 may include restrictions on loan offer extensions, such as a cap per user or system wide on installment loan amount or number of extended loan offers. Transaction flipping engine 142 may also use user information, such as repayment histories for users, credit information, available balances, budgetary information, and the like to determine which completed transactions are eligible for conversion to loans 144. For example, a budget of a user may be used to determine one or more of loans 144 based on when a user may require funds, such as due to an expected or current account deficit, and an amount of funds the user may require due to the deficit. Transaction flipping engine 142 may receive the budgetary information from client device 110 or may intelligently determine the information based on recurring bill payments, unusual or large purchases that affect a budget, account balances, or other information for the user. In some embodiments, determination of loans 144 by transaction flipping engine 142 for completed transactions may include scoring of transactions 140 based on one or more weights or factors to determine whether the scored transactions exceed a threshold requirement. In some embodiments, the highest or a subset of the highest scored transactions may be selected for loans 144.

Once data for loans 144 have been determined by transaction flipping engine 142, transaction processing application 132 may further generate and/or populate interface data and elements for transaction application 112 on client device 110 that displays the offer to flip the transaction to an installment loan within display 120. The interface data may include information for loans 144, such as an amount, an associated transaction that is being flipped, and/or loan terms. The interface elements may include one or more fields, options, or other interactable interface element that allows for acceptance or refusal of the extended installment loan conversion of a previous transaction. Transaction processing application 132 may transmit the interface data and elements for client device 110 over network 150, which may be the dynamically generated, populated, and/or displayed in display 120 of transaction application 112. Further, transaction processing application 132 may receive an acceptance of one or more of loans 144 displayed through display 120. In response, transaction flipping engine 142 may rescore the associated transaction for the flip offer to the installment loan and determine whether the offer is still valid. If so, transaction processing application 132 may implement a process to accept and issue the correspond one or more of loans 144, for example, by requesting user data and/or contacting a loan granting entity. However, if not, the offer may be revoked and transaction processing application 132 may update client device 110 of the revocation. If an installment loan is accepted and extended to the user based on the flip offer, transaction flipping engine 142 and/or transaction processing application 132 may monitor the corresponding past transaction for a return or reversal of all or a portion of the funds of the past transaction. In the event of a refunding of all or a portion of the funds, the user may be offered with one or more options to maintain the loan, payoff the installment loan, and/or request determination of another flip offer for another transaction.

In various embodiments, transaction processor 130 includes other applications 134 as may be desired in particular embodiments to provide features to transaction processor 130. For example, other applications 134 may include security applications for implementing server-side security features, programmatic client applications for interfacing with appropriate application programming interfaces (APIs) over network 150, or other types of applications. Other applications 134 may contain software programs, executable by a processor, including a graphical user interface (GUI), configured to provide an interface to the user when accessing transaction processor 130, where the user or other users may interact with the GUI to more easily view and communicate information. In various embodiments, other applications 134 may include additional connection and/or communication applications, which may be utilized to communicate information to over network 150.

Additionally, transaction processor 130 includes database 136. Database 136 may store various identifiers associated with client device 110. Database 136 may also store account data, including payment instruments and authentication credentials, as well as transaction processing histories and data for processed transactions. Database 136 may store financial information and tokenization data. Database 136 may further store data necessary for transaction flipping engine 142 to determine loans 144 based on transactions 140, such as factors and data for scoring transactions and/or selecting transaction for conversion to loans 144. For example, user and transaction data may be stored to database 136, as well as other trends, goals, weights, and/or additional information necessary to determine loans 144 intelligently and provide data within an interface to accept one or more of loans 144.

In various embodiments, transaction processor 130 includes at least one network interface component 138 adapted to communicate client device 110 and/or another device/server for a merchant over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

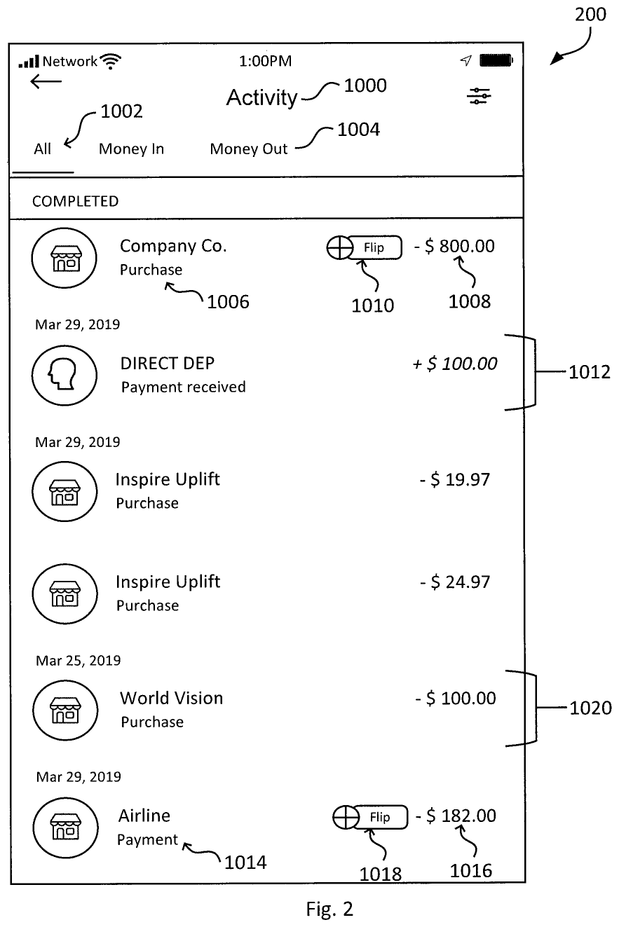

FIG. 2 is a first exemplary interface for dynamically displaying interface elements and options to convert a past processed transaction to an installment loan or other revolving account transaction, according to an embodiment. Environment 200 includes an activity display interface 1000 displayed by a device, such as client device 110 in system 100 of FIG. 1. In this regard, activity display interface 1000 may be displayed based on transaction and user data processed by a machine learning engine to dynamically and intelligently offer installment loans as a conversion of previously processed transactions. This process may be provided by an entity through a platform or portal provided by the entity, such as an online transaction processor.

In activity display interface 1000, a user may view one or more transactions through a particular display, such as an all transactions display 1002 or an outgoing transactions display 1004. As shown in environment 200, the all transactions display 1002 is selected to show outgoing and incoming past transactions, including transaction information for each transaction that was previously processed using the account associated with activity display interface 1000. For example, a transaction 1006 includes an amount 1008 and has a flip offer 1010 to convert amount 1008 to an installment loan for transaction 1006. Similarly, a transaction 1014 includes an amount 1016 and has a flip offer 1018 to convert amount 1016 to an installment loan for transaction 1014. Flip offer 1010 for transaction 1006 and flip offer 1018 for transaction 1014 may be determined using a recommendation engine that may utilize factors or weights for one or more of transaction data, user data, and/or service provider data to determine to offer flip offer 1010 and flip offer 1018 to the user corresponding to activity display interface 1000.

For example, installment loans extended to users may be limited by a maximum amount or number of extended loans. Additionally, transaction information may be used to determine whether a transaction is eligible to be flipped, such as based on items in the transaction, a merchant, a time of the transaction, or other information. The transaction information may indicate potential for fraud if an installment loan is offered on the corresponding transaction or may otherwise indicate whether an installment loan can be offered based on partner agreements, policies, and the like. User information and qualifications may also be used to determine whether to extend flip offer 1010 and flip offer 1018 through activity display interface 1000. In some embodiments, the engine may score both of transaction 1006 and transaction 1014 for flip offer 1010 and flip offer 1018, respectively, and determine that the scores exceed a threshold or required score. If so, flip offer 1010 and flip offer 1018 may be extended by dynamically generating and displaying one or more interface elements, shown as a button that allows for acceptance within the interface of flip offer 1010 and flip offer 1018. The interface element may be automatically and dynamically generated and displayed through activity display interface 1000 so that the user may view the corresponding offer and accept the offer.

However, in contrast, a transaction 1012 and a transaction 1020 may instead not qualify for an offer for a conversion to an installment loan, and therefore no interface element is generated or displayed in conjunction with the transaction. For example, transaction 1012 and/or transaction 1020 may be scored using a recommendation engine based on the aforementioned factors, such as user qualifications, transaction amounts or limits, loan amounts or limits, transaction information (e.g., merchant, items, etc.), or other data. If the scored transaction does not meet a score or threshold, then transaction 1012 and/or transaction 1020 may not be offered to be converted into an installment loan. In other embodiments, transaction 1012 and/or transaction 1020 may not qualify for conversion or flipping because a payment instrument used to process transaction 1012 and/or transaction 1020 may have a partnership agreement with the service provider so that loans are not extended to the user for transaction 1012 and/or transaction 1020. In this regard, the partnership agreement may dictate that the service provider does not cross sell products, such as installment loans on transactions paid for using the payment instrument for transaction 1012 and/or transaction 1020.

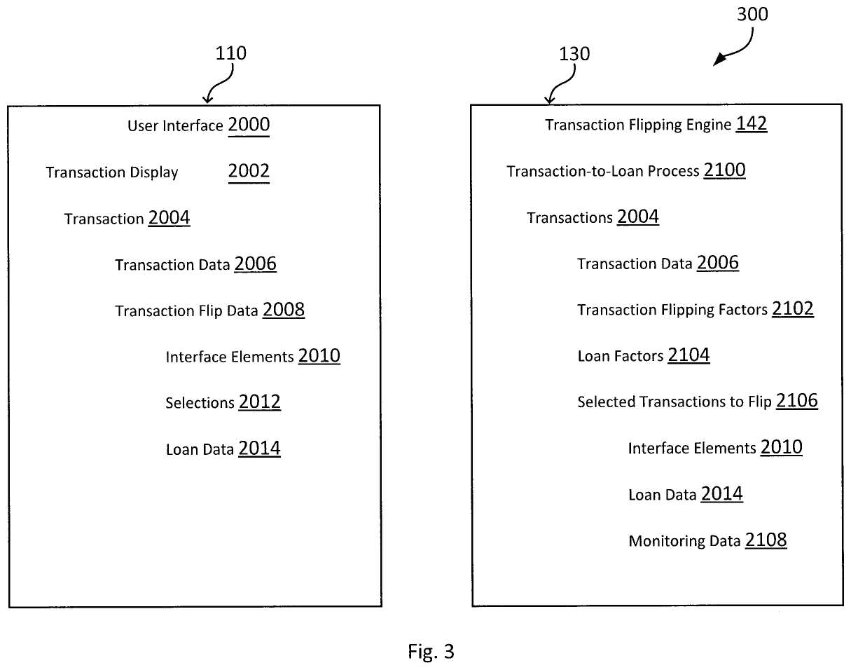

FIG. 3 is an exemplary system environment where a user device and a transaction processor may interact to intelligently determine and display interface options to convert a past processed transaction to an installment loan, according to an embodiment. System 300 of FIG. 3 includes client device 110 and transaction processor 130 discussed in reference to system 100 of FIG. 1. In this regard, client device 110 and transaction processor 130 may provide one or more processes to suggest previously processed transactions that may be eligible to be flipped into one or more installment loans for all or part of the transaction cost.

A user interface 2000 may be provided on client device 110 by an application on the device, such as transaction application 112 in system 100 of FIG. 1. User interface 2000 may display data through an application data display, which displays and updates application data to a user based on incoming data from a service provider, such as transaction processor 130. In this regard, user interface 2000 includes a transaction display 2002 that may display and update (e.g., in real-time) data for a transaction history of a user, including transactions within the history (e.g., previously processed and paid for) that qualify for conversion into an installment loan. Transaction display 2002 includes a transaction 2004 that may correspond to a previous transaction, such as an outgoing payment by the user to another user, merchant, or other entity, including purchases, transfers, and the like. Transaction 2004 includes transaction data 2006 that describes the transaction, such as an amount, payee or payor (e.g., for incoming payments), items or services purchased, a time, a description, or other information (including Level 2 and/or Level 3 card data that more granularly describes the transaction made using a payment card). Additionally, in order to identify transaction 2004 for flipping and/or request a flip offer eligibility assessment of transaction 2004, the user may be provided with a functionality to identify transaction 2004, such as through transaction display 2002. The user may also identify transaction 2004 by naming the transaction (e.g., an item name, merchant name, date, etc.), describing the transaction, adding a photograph of a receipt or item in the transaction. The user may also cluster multiple transactions together for flipping and/or determining a flip offer eligibility assessment. For example, all transaction through a time period or for a purchase (e.g., Christmas 2018, for a new business, etc.) may be identified and requested to be combined in a single installment loan, revolving credit transaction, or other offer.

Using transaction data with additional information, training factors, and weights from transaction flipping engine 142 of transaction processor 130, transaction flip data 2008 may also be provided to client device 110 and displayed within transaction display 2002 of user interface 2000, including interface elements 2010 to accept an installment loan offer that converts a previous transaction to the loan, selections 2012 may be the user of interface elements 2010, and/or loan factors 2014 that further describe the installment loan offer. Thus, transaction processor 130 may execute a transaction flipping engine 142 to generate transaction flip data 2008 for client device 110. Transaction flipping engine 142 includes a transaction-to-loan process 2100 that may be trained and generated based on one or more factors or weights for transaction flipping engine 142, past transaction and user data, and other information used to intelligently train a machine learning engine. Transaction-to-loan process 21000 may access transaction 2004 locally (e.g., from locally stored data in a database) or remotely from client device 110, which includes transaction data 2006 for transactions 2004. Additionally, transaction-to-loan process 2100 for transaction flipping engine 142 includes transaction flipping factors 2102 used to first train the engine based on established for transaction flipping engine 142, and second to select one or more previously processed transactions for offering to flip its payment into an installment loan for all or a portion of the payment amount. Transaction flipping factors 2102 may be based on budgetary concerns set by a user, detection of abnormal, large, or uncommon payments, known bills or upcoming payments of a user, known assets of the user including upcoming assets that the user expects to receive, account limitations or minimums required or requested by the user, and/or user requests for installment loans. Additionally, loan factors 2104 may affect offering of installment loan conversions for transactions, which may include partner agreements for transaction processor 130 (e.g., whether a partner service provider affiliated with transaction processor 130 affects offering of an installment loan due to the partner or partner card type), loan amounts and/or terms (including interest, flat fees, and the like), loan caps on amounts or number, and other loan restrictions or limitations. Loan factors 2014 may also be associated with whether particular transactions qualify to be flipped, for example, based on the items in the transaction, the merchant for the transaction, the amount or time of the transaction, or other transactional information that may risk potential fraud or otherwise violate a policy of transaction processor 130.

Using the aforementioned information, transaction flipping engine 142 may determine selected transactions to flip 2106, which includes transaction 2004. Thus, selected transactions to flip 2106 include transaction flip data 2008 sent to client device 110 and dynamically populated or displayed within user interface 2000. Transaction processor 130 may therefore generate and/or display interface elements 2010 associated with acceptance of an installment loan conversion of transaction 2004. Acceptance may be performed through various inputs, such as text input, touch screen inputs, and/or voice inputs. For example, interface elements 2010 may be presented through a graphical user interface (GUI) of a device, through an interactive voice response (IVR) system or other telephonic phone system, through a chat messenger and messaging application, and/or through another audio system (e.g., an automated voice system, such as Alexa®). Thus, the user may utilize a corresponding input to accept the flip offer for interface elements 2010. Transaction processor 130 may further provide loan factors 2014 to client device 110 so that the user may further review the particulars of the installment loan conversion or flip. Moreover, transaction flipping engine 142 may generate monitoring data 2108 when monitoring transaction display 2002 and additional actions by the user to determine compliance with the terms of the offered installment loan conversion/flip of transaction display 2002 so that the offer may be revoked, or other offers may be determined. User interface 2000 may also include or have navigation to a summary page for all outstanding installment loans, revolving credit transactions, and/or other extended loans/credit for the user, which may be used to show the original transaction for the flip offer, as well as details of the flip offer and accepted loan or credit.

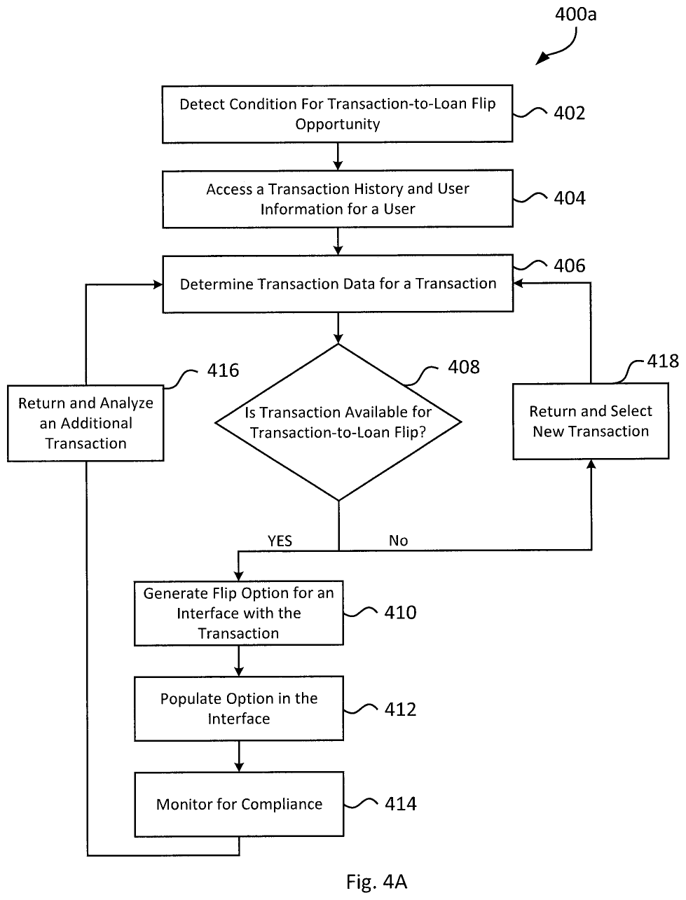

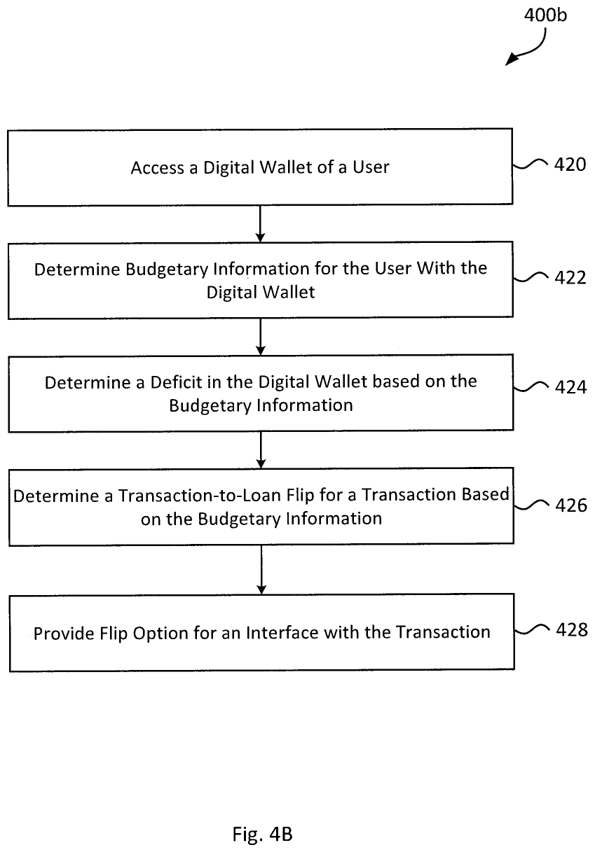

FIG. 4A is a flowchart of an exemplary process for intelligent population of interface elements for converting transactions, according to an embodiment. Note that one or more steps, processes, and methods described herein of flowchart 400a may be omitted, performed in a different sequence, or combined as desired or appropriate.

At step 402 of flowchart 400a, a condition for a transaction-to-loan flip opportunity may be detected by an intelligent engine of a service provider based on data particular to a user and/or transaction history of the user. For example, a budget of a user may be used to determine that the user requires funds or may require funds at a future time, such as to cover a bill or provide enough money in the user's account to cover future purchases (e.g., food, gas, and the like). The opportunity may also be based more generally of the user's or transaction's qualification for a flip offer of the transaction's payment to an installment loan. If the condition for the opportunity is detected, at step 404, a transaction history and user information for the user is accessed, which may be used based on the opportunity to detect one or more transactions available to be flipped. For example, the transaction information may be for multiple transactions, each of which may include data that indicates whether the payment can be flipped to a loan or not (e.g., based on fraud or a policy). Additionally, the user may be required to qualify based on the user's history of repayment, credit worthiness, other loans or assets, and the like.

Thus, at step 406, transaction data for a particular transaction is determined and is processed to determine whether, at step 408, the transaction is available for a transaction-to-loan flip offer. This determination is based on the particular transaction's data, such as payment details, payee/payor information, purchase item/service details, and other information used to determine qualification of the transaction's payment to flip to an installment loan. This may further be based on policy factors set for the engine performing the flip or conversion offer, which also may include weights set for the particular factors. Thus, the engine may perform a scoring of the transaction, and determine whether the transaction meets a minimum score or threshold. The engine may also choose the transaction based on being within a certain percentile, such as the top 80% of all scored transactions (e.g., offering to flip any transaction scored in the top 80% of all transactions while declining to flip any transaction scored below that threshold). The grouping, threshold, or percentile may also be based on whether limits of loans are met, such as a cap on an amount or a number of extended loans.

If the transaction is determined to be available to flip into the loan at step 408, then flowchart 400a proceeds to step 410 where a flip option for an interface having the transaction is generated. The flip option corresponds to an interface element that may be selectable to view additional transaction and/or loan information and interact with the flip offer, including accepting or declining the flip offer. Thus, this may correspond to a particular field, box, or other selectable option that is not normally displayed in the interface but may be generated and/or provided based on the transaction-to-loan flip offer generated by the recommendation and/or scoring engine of the service provider. The service provider may then cause this option to be dynamically populated or displayed within an interface on a user device, such as a mobile device or other client device. The option may be displayed remotely by the service provider and automatically or without user input, at step 412. At step 414, the transaction and flip offer are monitored for compliance in order to determine whether the offer may be revoked. Flowchart 400a then proceeds to step 416, where the process returns to step 406 and analyzes an additional transaction of the user. However, if at step 408 the transaction-to-loan flip is not available for the particular transactions, then flowchart 400a proceeds to step 418 where another new transaction is selected, which is processed by returning to step 406.

FIG. 4B is a flowchart of an exemplary process for intelligent population of interface elements for converting transactions based on a budget of a user, according to an embodiment. Note that one or more steps, processes, and methods described herein of flowchart 400b may be omitted, performed in a different sequence, or combined as desired or appropriate.

At step 420 of flowchart 400b, a digital wallet and/or other account of a user is accessed, such as one storing one or more funding instruments and a transaction history of completed transactions using the funding instruments. This may be done by a service provider servicing the digital wallet. The transaction history may include details of the completed transactions, including amounts of the payments outgoing to other entities based on the completed transactions, information for the entities, and the like. Additionally, based on the digital wallet and/or other type of account provided by service provider, budgetary information for the user with the digital wallet (or one or more funding instruments in the digital wallet) may be determined, at step 422. The budgetary information may include information of past incoming and/or outgoing funds, including completed transactions, bills, debts or assets, past incoming assets or wages, and the like. The budgetary information may also include expected or upcoming debits and/or credits, such as wages, bills and other expected outgoing payments, desired items, incoming assets (e.g., sale of investments, tax refunds, and the like), or other expected adjustments to a user's balance, budget, or extended credit. Additionally, the budgetary information may include user preferences for a budget of a user, such as a minimum account balance, a maximum monthly expenditure, a planned purchase by the user, and the like.

Using the aforementioned information, a deficit in the digital wallet is determined based on the budgetary information. The deficit may be caused by a past completed transaction or due to an expected or upcoming purchase or required payment. For example, a past completed transaction may be for an uncommon or large purchase, such as a new car or television. Such a completed transaction may therefore adversely affect the user's budget or budgetary preferences. Further, incoming assets or wages may be insufficient to cover an upcoming bill or expected purchase. Thus, different types of budgetary information may cause an actual or expected deficit in the balance, funds, or other assets in the user's digital wallet.

In response to the deficit in the user's digital wallet, a transaction-to-loan flip for a transaction may be determined based on the budgetary information, at step 426. The transaction-to-loan flip for a completed transaction in the user's transaction history (e.g., completed transactions using the digital wallet) may be determined in a similar manner to steps 404 and 406 of flowchart 400a, where a transaction is identified, scored, and/or processed based on user information for the user and the transaction history for the digital wallet. This allows only those qualifying transactions to be identified, which may further be identified and/or selected based on the budgetary information for the user. For example, the budgetary information may be used to select an amount or a specific transaction that satisfies the deficit amount or cause. Once the completed transaction has been identified, at step 428 a flip option for at least a portion of the amount of the completed transaction is provided within an interface for the digital wallet, where the interface has the completed transaction displayed. Generating and displaying the flip option may be performed in a similar manner to steps 410-416 of flowchart 400a.

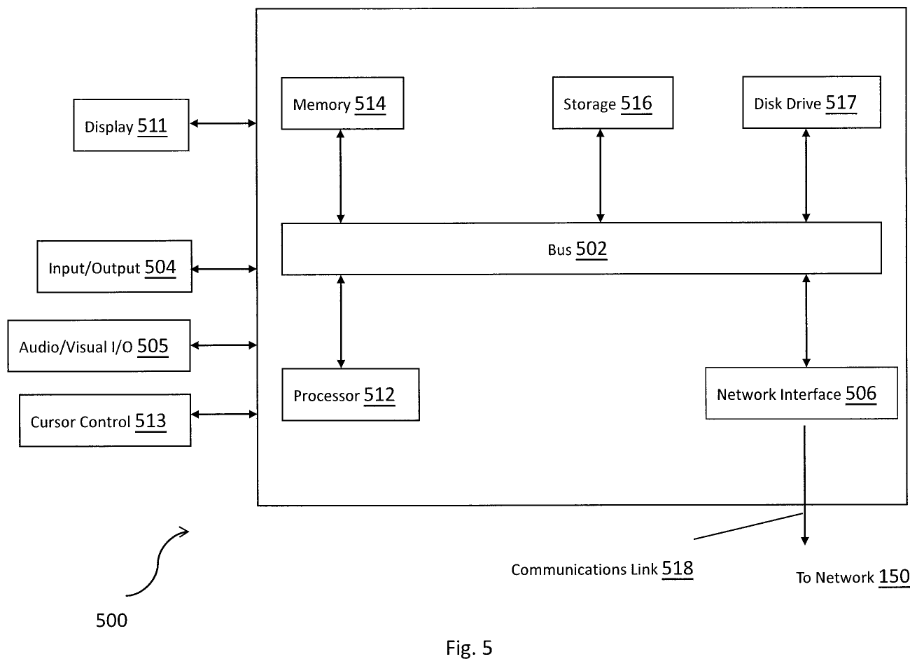

FIG. 5 is a block diagram of a computer system suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
accessing a digital wallet of a user, wherein the digital wallet comprises instrument data for a payment instrument and a transaction history for the digital wallet;
determining, by a recommendation engine, that a transaction previously processed using the digital wallet qualifies for a conversion into an installment loan based on the instrument data, the transaction history, and eligibility factors for the system; and
in response to determining that the transaction qualifies for conversion into the installment loan, dynamically generating an interface element and associating the interface element with the transaction, wherein a selection of the interface element causes the transaction to be converted into the installment loan.

2. The system of claim 1, wherein prior to the determining that the transaction previously processed using the digital wallet qualifies for the conversion into the installment loan, the operations further comprise:
determining, using the recommendation engine, a funding requirement for the user based on the digital wallet and user data for the user; and
determining that an amount to resolve the funding requirement is unavailable to the user through the digital wallet,
wherein the transaction is determined in response to determining that the amount is unavailable through the digital wallet.

3. The system of claim 2, wherein the funding requirement comprises a recurring bill of the user, and wherein the funding requirement is further determined based on at least one of a past paid bill by the user, a linked billing account with the digital wallet, or a bill request by a billing entity associated with the recurring bill.

4. The system of claim 2, wherein the determining the funding requirement comprises:
accessing budget information for the user; and
determining that the budget information indicates that the user owes the funding requirement at a future time.

5. The system of claim 2, wherein the funding requirement is further determined based on at least one of a user browsing history, a user shopping list, a user purchase request, or a user financing preference.

6. The system of claim 2, wherein the funding requirement comprises a portion of a split payment owed by the user for the amount, and wherein the funding requirement is determined in response to receiving the split payment from an entity or another user requiring the portion of the split payment from the user.

7. The system of claim 1, wherein the instrument data further comprises a plurality of payment instruments including the payment instrument, and wherein the operations further comprise:
selecting, using the recommendation engine, the payment instrument for the transaction based on at least one of a partner agreement with a partner service for the payment instrument, an installment loan limit on the payment instrument, or a purchase type of the transaction using the payment instrument.

8. The system of claim 1, wherein the determining that the transaction previously processed using the digital wallet qualifies for the conversion into the installment loan comprises:
accessing a plurality of transactions previously processed using the digital wallet;
scoring, using the recommendation engine, each of the plurality of transactions for the conversion into the installment loan; and
selecting the transaction from the plurality of transactions based on a highest score of the each of the plurality of transactions.

9. The system of claim 1, wherein the transaction is further determined based on at least one of a cap limit on the installment loan, an interest rate for the installment loan, a transaction type for the transaction, or a transaction amount for the transaction, and wherein the operations further comprise:
determining whether to revoke the installment loan based on a further action by the user associated with the digital wallet.

10. The system of claim 1, wherein the operations further comprise:
receiving the selection of the interface element via the interface element in a user interface corresponding to the interface element; and
determining whether to provide the installment loan to the user through the digital wallet based on the transaction and user information for the user.

11. A method comprising:
accessing, by a service provider, an account of a user, wherein the account comprises first data for a plurality of payment instruments and a transaction history of transactions processed using the plurality of payment instruments, and wherein the account further comprises second data associated with a budget of the user;
determining a deficit in the budget of the user based on the first data and the second data;
determining, without user input from the user and based on the deficit, that a completed transaction is available for conversion to one or more installment loans for an amount of the completed transaction, wherein the amount is at least a first portion of a total amount for the completed transaction;
generating an interface element comprising an option to accept the one or more installment loans; and
causing to be displayed, on a computing device of the user, the interface element within a user interface during a display of at least a second portion of the first data that includes the completed transaction.

12. The method of claim 11, wherein the second data for the budget of the user is established for the account in response to an opt-in of the user for a budgetary management process with the account.

13. The method of claim 11, wherein prior to accessing the account of the user, the method further comprises:
receiving, by the service provider, a request to access the account of the user;
causing to be displayed, on the computing device, account information for the account via the user interface provided by the service provider for the account, wherein the user interface further comprises a process to enter user preferences for the budget;
receiving the user preferences via the user interface; and
determining the second data based on the user preferences.

14. The method of claim 11, wherein the one or more installment loans are based on a plurality of loan recommendation factors based on at least one of loan information for the service provider or user information for the user, wherein the plurality of loan recommendation factors comprise at least one of a maximum loan amount to the user with the service provider, a maximum number of loans available to the user with the service provider, a funding instrument preference by the user, a return policy for at least one of the transactions, a transaction type for a transaction, a transaction risk for a particular transaction type, loan terms available to the user with the service provider, or a loan history of the user with at least one of the service provider, an affiliated partner service provider, or a subsidiary of the service provider.

15. The method of claim 11, wherein prior to the generating the interface element, the method further comprises one of:
receiving a request for the one or more installment loans via the user interface; or
detecting an account condition for the account, wherein the account condition comprises a requirement for the one or more installment loans based on the first data and the second data.

16. The method of claim 11, wherein the user interface comprises one of an account interface of one of a website for the service provider or a dedicated application of the service provider, a transaction history message for the transaction history, a receipt interface associated with a receipt for at least the completed transaction, or a data feed provided for the transaction history.

17. The method of claim 11, wherein prior to causing the interface element to be displayed, the method further comprises:
requesting an authentication of the user via the user interface;
receiving an authentication credential from the computing device via the user interface; and
authenticating the computing device for display of the interface element based on the authentication credential.

18. A non-transitory machine-readable medium having stored thereon machine-readable instructions executable to cause a machine to perform operations comprising:
determining, based on a digital wallet of a user and a payment for a transaction using the digital wallet, that the user has insufficient funds from funding instruments linked to the digital wallet to resolve the payment, wherein the digital wallet comprises previous transactions processed by the user using the funding instruments;
determining, by a trained loan conversion engine based on a plurality of conversion factors for previous transactions that have been converted, that one of the previous transactions is available to be converted to a loan associated with an amount of funds to resolve the payment;
generating a conversion offer for the one of the previous transactions, wherein the conversion offer comprises an option to convert the one of the previous transactions to the loan; and
presenting the conversion offer via a graphical user interface of a device for the user.

19. The non-transitory machine-readable medium of claim 18, wherein the determining that the user has insufficient funds comprises receiving a request for the loan via a wallet interface for the digital wallet displayed by the graphical user interface of the device, wherein the conversion offer is displayed within the wallet interface.

20. The non-transitory machine-readable medium of claim 18, wherein the operations further comprise:
accessing wallet information for the digital wallet comprising at least funding information for the funding instruments and a transaction history for the previous transactions,
wherein the determining that the user has insufficient funds is by the trained conversion engine based on the wallet information by the trained loan conversion engine.
